(19) United States
(12) Patent Application Publication
(10) Pub. No.: US 2026/0252152 A1
(43) Pub. Date: Aug. 27, 2026

(54) THERMAL AWARE PERFORMANCE/POWER MANAGEMENT FOR CONCURRENT OPERATION OF LARGE MODELS

(71) Applicant: QUALCOMM Incorporated, San Diego, CA (US)

(72) Inventors: Siddhant GUPTA, San Diego, CA (US); Nikhil Kumar KANSAL, San Diego, CA (US)

(21) Appl. No.: 19/065,915

(22) Filed: Feb. 27, 2025

(51) Int. Cl. G06F 1/26

(52) U.S. Cl. CPC G06F 1/26

(57) ABSTRACT

A processor-implemented method for thermal aware performance/power management for concurrent operation of large models includes monitoring a first temperature of one or more of the plurality of processors. Each of the one or more processors executes a machine learning model workload. The processor-implemented method also includes determining if the first temperature of the one or more of the plurality of processors is within one of a set of temperature zones. Power to the one or more of the plurality of processors is controlled based on the one of the set of temperature zones in which the first temperature of the one or more of the plurality of processors lies.

### FIELD OF THE DISCLOSURE

Aspects of the present disclosure generally relate to computer processors, and more specifically to thermal aware performance/power management for concurrent operation of large models.

### BACKGROUND

Artificial neural networks may comprise interconnected groups of artificial neurons (e.g., neuron models). The artificial neural network (ANN) may be a computational device or be represented as a method to be performed by a computational device. Convolutional neural networks (CNNs) are a type of feed-forward ANN. Convolutional neural networks may include collections of neurons that each have a receptive field and that collectively tile an input space. Convolutional neural networks, such as deep convolutional neural networks (DCNs), have numerous applications. In particular, these neural network architectures are used in various technologies, such as image recognition, speech recognition, acoustic scene classification, keyword spotting, autonomous driving, and other classification tasks.

With a wide range of applications, it may be desirable to operate multiple machine learning models concurrently on a device (e.g., edge device or data center). Operating such large models concurrently on different processors may lead to significant heat generation on the processors, such as neural processing units. Overheating processors may trigger automatic performance reduction (e.g., throttling) and may affect processor service quality.

### SUMMARY

Various aspects of the present disclosure are directed to an apparatus. The apparatus has at least one memory and a plurality of processors coupled to the at least one memory. At least one processor of the plurality of processors is configured to monitor a first temperature of one or more of the number of processors. Each of the one or more processors executes a machine learning model workload. The processor(s) is also configured to determine if the first temperature of the one or more of the number of processors is within one of a set of temperature zones. The processor(s) is further configured to control power to the one or more of the number of processors based on the one of the set of temperature zones in which the first temperature of the one or more of the number of processors lies.

In some aspects of the present disclosure, a processor-implemented method includes monitoring a first temperature of one or more of the number of processors. Each of the one or more processors executes a machine learning model workload. The processor-implemented method also includes determining if the first temperature of the one or more of the number of processors is within one of a set of temperature zones. The processor-implemented method further includes controlling power to the one or more of the number of processors based on the one of the set of temperature zones in which the first temperature of the one or more of the number of processors lies.

Various aspects of the present disclosure are directed to an apparatus. The apparatus includes means for monitoring a first temperature of one or more of the number of processors. Each of the one or more processors executes a machine learning model workload. The apparatus also includes means for determining if the first temperature of the one or more of the number of processors is within one of a set of temperature zones. The apparatus further includes means for controlling power to the one or more of the number of processors based on the one of the set of temperature zones in which the first temperature of the one or more of the number of processors lies.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of a neural network using a system-on-a-chip (SOC), including a general-purpose processor in accordance with certain aspects of the present disclosure.

FIGS. 2A, 2B, and 2C are diagrams illustrating a neural network in accordance with aspects of the present disclosure.

FIG. 3 is a block diagram illustrating an exemplary deep convolutional network (DCN) in accordance with aspects of the present disclosure.

FIG. 4 is a block diagram illustrating an exemplary software architecture that may modularize artificial intelligence (AI) functions, in accordance with aspects of the present disclosure.

FIG. 5 is graph illustrating example thermal zones of a neural processor core, in accordance with various aspects of the present disclosure.

FIG. 6 is a flow diagram illustrating an example process for thermal zone-based power/performance management, in accordance with various aspects of the present disclosure.

FIG. 7 is a flow diagram illustrating a processor-implemented method for thermal aware power/performance management for concurrent large models, in accordance with various aspects of the present disclosure.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used to mean “serving as an example, instance, or illustration.” Any aspect described as “exemplary” is not necessarily to be construed as preferred or advantageous over other aspects.

Although particular aspects are described, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks, and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Operating various large machine learning models such as large language models (LLM) (e.g., LLAMA2, MAGIC, OPPO-BAICHUAN) on a device (e.g., edge device or data center) may specify extensive processing power leading to significant heat generation on processors such as neural processing units (NPUs). A challenge in running large models on edge devices and data centers is that junction temperature may rapidly increase when running large models (e.g., LLMs) concurrently with other models or high processing use-cases, such as video games.

Conventional approaches attempt to avoid overheating the processors by triggering automatic performance reductions, such as throttling, affecting NPU service quality. Throttling of the processors is a technique in which the clock speed is reduced when the temperature in the system causes a system overheating issue.

However, conventional approaches such as processor throttling, also referred to as dynamic frequency scaling, may significantly reduce performance and may lead to increased latency and user frustration. This problem is exacerbated when multiple large models are currently being executed because the processor temperatures may rapidly rise, leading to earlier processor throttling. Furthermore, conventional approaches do not consider thermal management of concurrent execution of large model workloads on multiple processors.

Accordingly, to address these and other issues, aspects of the present disclosure are directed to thermal aware power/performance management for concurrent operation of large models.

Particular aspects of the subject matter described in this disclosure can be implemented to realize one or more of the following potential advantages. In some examples, the described techniques (e.g., monitoring a first temperature of one or more processors, determining if the first temperature of one or more processors is within one of a set of temperature zones, and controlling power to the one or more processors based on the temperature zone). The described techniques may reduce temperature and dynamic frequency scaling (e.g., throttling) for concurrent large machine learning model workloads and may reduce power consumption.

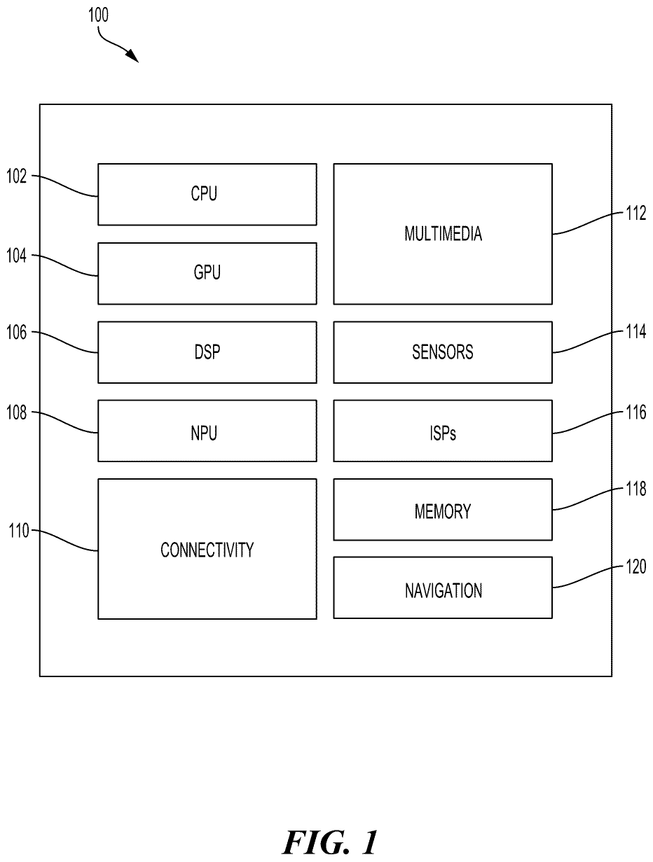

FIG. 1 illustrates an example implementation of a system-on-a-chip (SOC) 100, which may include a central processing unit (CPU) 102 or a multi-core CPU configured for thermal aware power/performance management for concurrent operation of large models. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU 108 is implemented in the CPU 102, DSP 106, and/or GPU 104. The SOC 100 may also include a sensor processor 114, image signal processors (ISPs) 116, and/or navigation module 120, which may include a global positioning system.

The SOC 100 may be based on an ARM, RISC-V (RISC-five), or any reduced instruction set computing (RISC) architecture. In aspects of the present disclosure, the instructions loaded into the general-purpose processor 102 may include code to monitor a first temperature of one or more of the plurality of processors, each of the one or more processors executing a machine learning model workload. The instructions loaded into the general-purpose processor 102 may also include code to determine if the first temperature of the one or more of the plurality of processors is within one of a set of temperature zones. The instructions loaded into the general-purpose processor 102 may further include code to control power to the one or more of the plurality of processors based on the one of the set of temperature zones in which the first temperature of the one or more of the plurality of processors lies.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

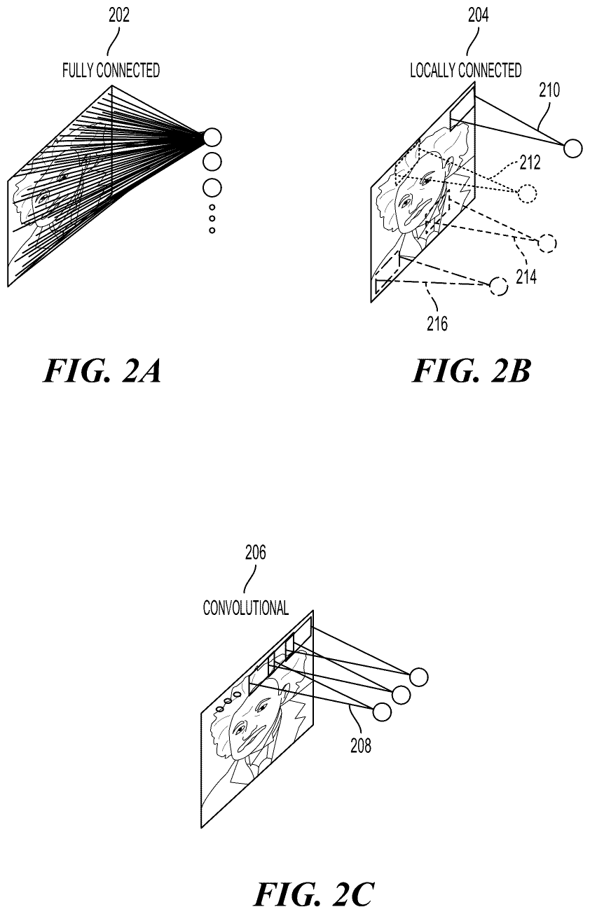

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer because the higher layer neurons in a given region may receive inputs that are tuned through training to the properties of a restricted portion of the total input to the network.

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful.

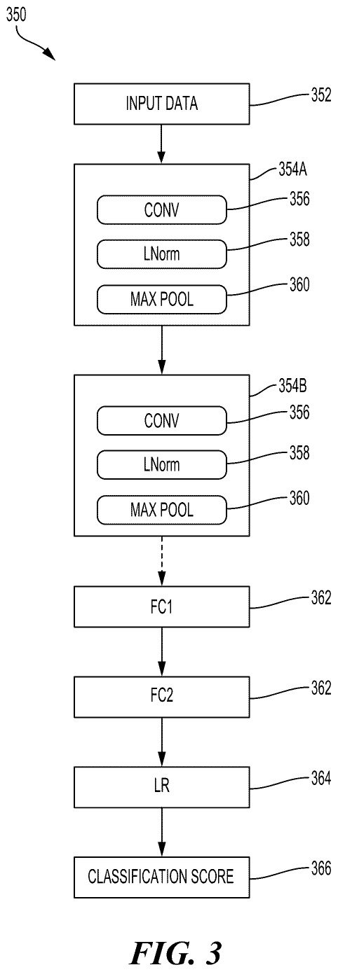

FIG. 3 is a block diagram illustrating a DCN 350. The DCN 350 may include multiple different types of layers based on connectivity and weight sharing. As shown in FIG. 3, the DCN 350 includes the convolution blocks 354A, 354B. Each of the convolution blocks 354A, 354B may be configured with a convolution layer (CONV) 356, a normalization layer (LNorm) 358, and a max pooling layer (MAX POOL) 360.

Although only two of the convolution blocks 354A, 354B are shown, the present disclosure is not so limiting, and instead, any number of the convolution blocks 354A, 354B may be included in the DCN 350 according to design preference.

The convolution layers 356 may include one or more convolutional filters, which may be applied to the input data to generate a feature map. The normalization layer 358 may normalize the output of the convolution filters. For example, the normalization layer 358 may provide whitening or lateral inhibition. The max pooling layer 360 may provide down sampling aggregation over space for local invariance and dimensionality reduction.

The parallel filter banks, for example, of a deep convolutional network may be loaded on a CPU 102 or GPU 104 of an SOC 100 (e.g., FIG. 1) to achieve high performance and low power consumption. In alternative embodiments, the parallel filter banks may be loaded on the DSP 106 or an ISP 116 of an SOC 100. In addition, the DCN 350 may access other processing blocks that may be present on the SOC 100, such as sensor processor 114 and navigation module 120, dedicated, respectively, to sensors and navigation.

The DCN 350 may also include one or more fully connected layers 362 (FC1 and FC2). The DCN 350 may further include a logistic regression (LR) layer 364. Between each layer 356, 358, 360, 362, 364 of the DCN 350 are weights (not shown) that are to be updated. The output of each of the layers (e.g., 356, 358, 360, 362, 364) may serve as an input of a succeeding one of the layers (e.g., 356, 358, 360, 362, 364) in the DCN 350 to learn hierarchical feature representations from input data 352 (e.g., images, audio, video, sensor data and/or other input data) supplied at the first of the convolution blocks 354A. The output of the DCN 350 is a classification score 366 for the input data 352. The classification score 366 may be a set of probabilities, where each probability is the probability of the input data including a feature from a set of features.

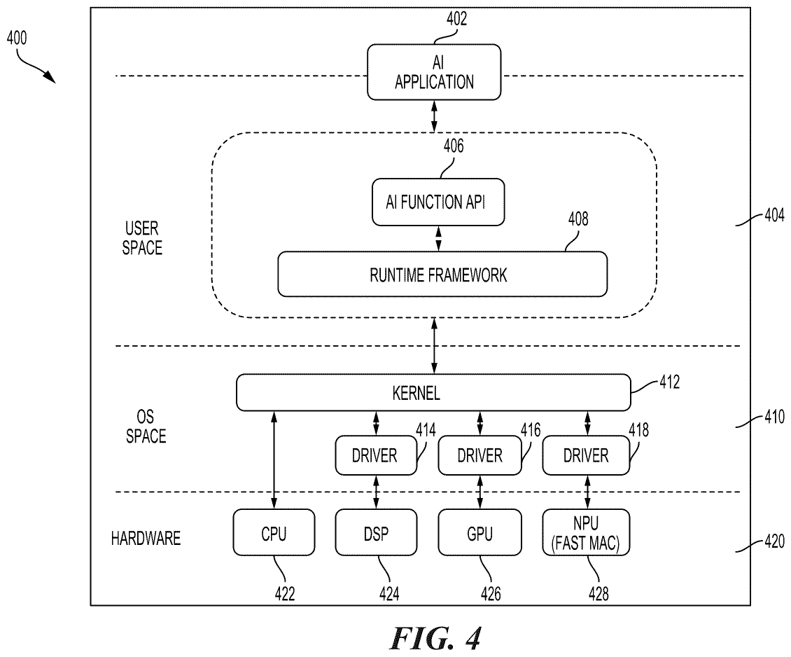

FIG. 4 is a block diagram illustrating an exemplary software architecture 400 that may modularize artificial intelligence (AI) functions. Using the architecture 400, applications may be designed that may cause various processing blocks of an SOC 420 (for example a CPU 422, a DSP 424, a GPU 426 and/or an NPU 428) (which may be similar to SOC 100 of FIG. 1) to support thermal aware power/performance management for concurrent operation of large models for an AI application 402, according to aspects of the present disclosure. The architecture 400 may, for example, be included in a computational device, such as a smartphone.

The AI application 402 may be configured to call functions defined in a user space 404 that may, for example, provide for the detection and recognition of a scene indicative of the location at which the computational device including the architecture 400 currently operates. The AI application 402 may, for example, configure a microphone and a camera differently depending on whether the recognized scene is an office, a lecture hall, a restaurant, or an outdoor setting such as a lake. The AI application 402 may make a request to compiled program code associated with a library defined in an AI function application programming interface (API) 406. This request may ultimately rely on the output of a deep neural network configured to provide an inference response based on video and positioning data, for example.

The run-time engine 408, which may be compiled code of a runtime framework, may be further accessible to the AI application 402. The AI application 402 may cause the run-time engine 408, for example, to request an inference at a particular time interval or triggered by an event detected by the user interface of the AI application 402. When caused to provide an inference response, the run-time engine 408 may in turn send a signal to an operating system in an operating system (OS) space 410, such as a Kernel 412, running on the SOC 420. In some examples, the Kernel 412 may be a LINUX Kernel. The operating system, in turn, may cause a continuous relaxation of quantization to be performed on the CPU 422, the DSP 424, the GPU 426, the NPU 428, or some combination thereof. The CPU 422 may be accessed directly by the operating system, and other processing blocks may be accessed through a driver, such as a driver 414, 416, or 418 for, respectively, the DSP 424, the GPU 426, or the NPU 428. In the exemplary example, the deep neural network may be configured to run on a combination of processing blocks, such as the CPU 422, the DSP 424, and the GPU 426, or may be run on the NPU 428.

As described, aspects of the present disclosure are directed to thermal aware power/performance management for concurrent operation of large models. In various aspects, idle/sleep periods may be intelligently introduced based on estimated zone-based slope values and temperature thresholds configured such that impact on performance may be limited.

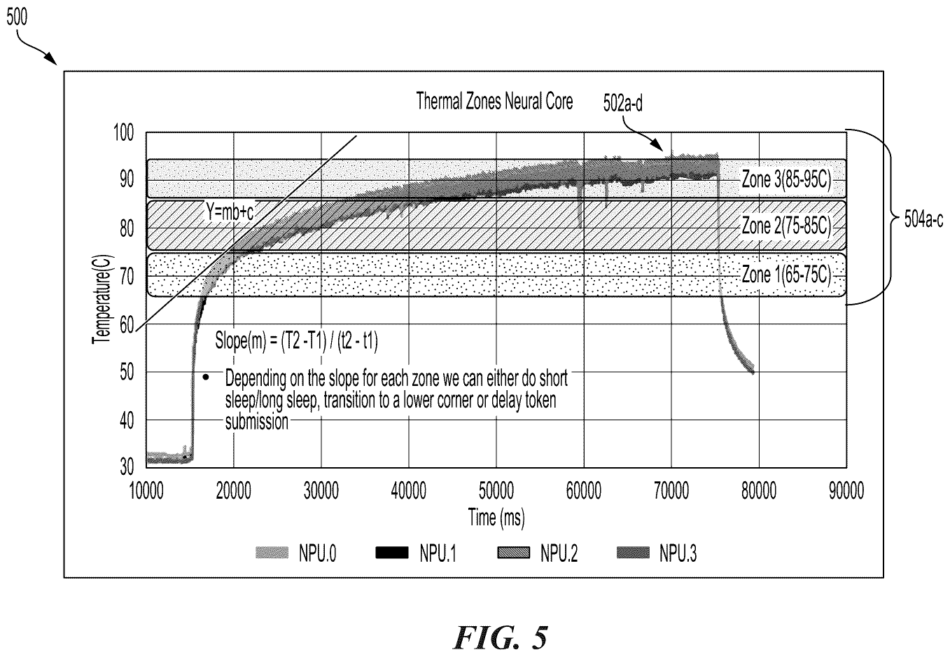

FIG. 5 is graph 500 illustrating example thermal zones of a neural processor core, in accordance with various aspects of the present disclosure. Referring to FIG. 5, curves 502a-d represent the temperature measured at each of multiple NPUs (e.g., NPU0, NPU1, NPU2, NPU3). The temperatures of the NPUs may be monitored for instance using one or more temperature sensors (e.g., 114 of FIG. 1). The graph 500 of FIG. 5 shows temperature curves for four NPUs, however, the number of curves, processors, or processor types are merely examples and not limiting.

Using the curves 502a-d, multiple temperature zones 504a-c may be defined. Temperature zone 1 (e.g., 504a) may include points in the curves at which the measured temperature is 65-75° C., temperature zone two (e.g., 504b) may include points at which the measured temperature is in the range 76-85° C., and temperature zone three (e.g., 504c) may include points at which the measured temperature is in the range 86-95° C. Although three temperature zones are shown in the graph 500 of FIG. 5, the present disclosure is not so limited and any number of temperature zones may be included according to design preference, for example. The number and size of the temperature zones may, for instance, be determined empirically or otherwise. In some aspects, when the temperature of any of the processors is above the range of temperature zone three (e.g., 86-95° C.), a critical error may occur. A critical error may trigger corrective action such as processor throttling, for instance.

The temperature zones 504a-c may be used for power/performance management. For example, the power/performance management may control the power and/or processor operation according to the temperature zones to reduce, and in some aspects, avoid critical errors as well as corrective actions. In various aspects, an estimate slope of the curve for each of the temperature zones (e.g., 504a-c) may trigger an idle period or a sleep period. Other factors may also be considered in determining whether to perform power management and to which degree. For instance (but not limitation), other factors considered may include a number and type of other workloads being concurrently processed by other processors of the device (e.g., edge device such as a smartphone, or a data center), system processing metrics, proximity of a current temperature to a critical temperature, etc.

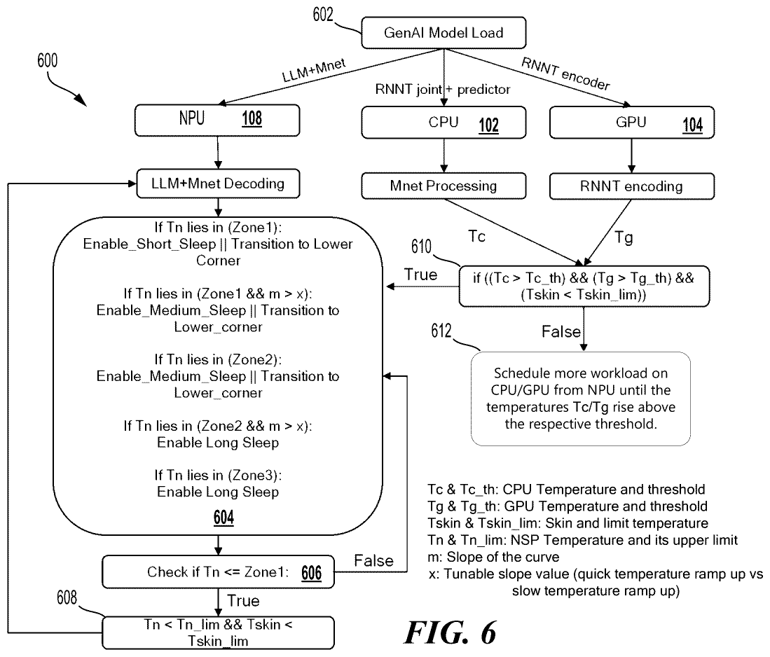

FIG. 6 is a flow diagram illustrating an example process 600 for thermal zone-based power/performance management, in accordance with various aspects of the present disclosure. Referring to FIG. 6, at block 602, one or more machine learning (ML) models may be loaded to each of one or more processors. In the example of FIG. 6, a generative artificial intelligence (AI) model may be loaded. Generative AI models may perform a wide range of tasks including creating new content such as text, images or videos, as well as natural language processing and many other tasks. To perform such tasks, generative AI models may utilize or integrate multiple ML models, which in some cases may operate concurrently. For example, as shown in FIG. 6, the generative AI model may operate a large language model (LLM) with a Mnet (LLM+Mnet), a recurrent neural network transducer (RNNT) with a joint predictor (RNNT+predictor), and an RNNT encoder. Mnet may refer to a multiscale kernel neural network. RNNT may refer to a sequence-to-sequence model for automatic speech recognition, for example.

The LLM+Mnet may be loaded to an NPU 108, the RNNT+predictor may be loaded to a CPU 102, and the RNNT encoder may be loaded to a GPU 104. Each of the processors may begin processing workloads for the respective ML models. Although, one of each processor type (e.g., CPU 102, GPU 104, and NPU 108) is shown in FIG. 6, it should be understood that multiple processors of each type may also be used to process the respective ML model workloads. Then, at block 604, the example process 600 may determine the temperature (Tₙ) of the NPU 108 and enable temperature zone-based sleep/idle modes. For example, the temperature (Tₙ) of the NPU 108 may be detected using one or more sensors (e.g., 114 of FIG. 1).

The zone (e.g., 504a-c) in which the temperature (Tₙ) lies may be determined. The slope of the temperature (Tₙ) curve (e.g., 504a-d) for the NPU 108 may also be determined according to Slope (m)=T₂−T₁/t₂−t₁, where Tₙ is the temperature and to is a time. If the temperature (Tₙ) is within the first zone (e.g., zone 1 504a of FIG. 5), then a short sleep mode may be enabled. During short sleep, the clock speed of NPU 108 may be reduced and certain functional blocks may be disabled temporarily (e.g., for a predetermined time period). In one example, a short sleep mode may comprise reducing the rail voltage (e.g., from 0.7 V to 0.5 V), incurring a short latency (e.g., 25 μs) in resuming from the short sleep mode. In some aspects, the process 600 may initiate a transition to lower operating parameters (e.g., frequency or voltage). Additionally, during the short sleep mode, state information including (but not limited to) cache and register states may be retained.

If the temperature (Tₙ) is either within the second zone or within the first zone (e.g., zone 1 504a of FIG. 5) and the slope m at the first zone is greater than a first predefined threshold value x, then a medium sleep mode may be enabled. The first predefined threshold may be a tunable slope value (e.g., based on how quickly the temperature may increase). In some aspects, different threshold values may be employed based on the temperature zone. In the medium sleep mode, the clock speed of NPU 108 may be reduced and certain functional blocks may be disabled temporarily (e.g., for a predetermined time period). Additionally, portions of the memory and/or internal busses may be powered down and state information (e.g., cache and register states) may be partially saved or flushed. As such, the wake up latency for medium sleep mode is greater than for short sheep mode.

If the temperature (Tₙ) is either within the third zone (e.g., zone 3 504c) or within the second zone (e.g., zone 2 504b), and the slope m is greater than the predefined threshold value x, then the process 600 may enable a long sleep mode. In the long sleep mode, the power of the NPU may be reduced, cache and internal registers may be flushed. For instance, the power supplied to the NPU 108 may be reduced to 0.2 V. In some aspects, during the long sleep mode, only critical state data in nonvolatile memory may be retained. The wakeup latency for the long sleep mode (e.g., 45 μs) may be greater than the wakeup latency for short sleep mode and the medium sleep mode.

The process 600 may transition to block 606. At block 606, the process 600 may check whether the temperature (Tₙ) is less than or equal to the temperatures of the first zone. In some aspects, the process 600 may additionally or alternatively consider whether the temperature (Tₙ) is less than or equal to the temperatures of the second zone. In doing so, the process 600 may determine whether the temperature (Tₙ) is in the first zone (e.g., zone 1 504a) (or the second zone (e.g., zone 2 504b)) to determine if the NPU 108 temperature has been reduced sufficiently. If the temperature has not been reduced (e.g., Tₙ>Zone 1), then the process 600 may return to block 604 to repeat the NPU temperature zone-based idle/sleep modes.

On the other hand, if the temperature (Tₙ) has been reduced (e.g., Tₙ≤Zone 1 504a), then at block 608, the process 600 may check whether the temperature (Tₙ) is less than the upper temperature limit (T_{n_lim}) and whether the surface temperature (Tₛₖᵢₙ) of the NPU 108 is less than a surface temperature limit (T_{skin_lim}). When the condition of block 608 is met, the process 600 may enable the NPU 108 to proceed with executing the ML model workload (e.g., LLM+Mnet decoding or other process).

At block 610, the process 600 may check whether the temperature (T_{c}) of the CPU 102 is greater than a predefined CPU temperature threshold (T_{c_th}) and the temperature (T_{g}) of the GPU 104 is greater that a predefined GPU temperature threshold (T_{q_th}). In some aspects, the process may further determine whether the surface temperature (Tₛₖᵢₙ) is below the surface temperature limit (T_{skin_lim}). If the CPU temperature (T_{c}) exceeds the CPU temperature threshold (T_{c_th}) and the GPU temperature (T_{g}) exceeds the GPU temperature threshold (T_{g_th}) and the surface temperature (Tₛₖᵢₙ) is below the surface temperature limit (T_{skin_lim}), then the process 600 may return to block 604 to repeat the NPU temperature zone-based idle/sleep modes. If the condition is not met then, at block 612, the process 600 may schedule more workload on CPU 102 and/or GPU 104 from NPU 108 until the temperature rises above the said threshold (e.g., return to 610). Accordingly, the ML workload may be balanced among the NPU 108 and one or more of the CPU 102 and the GPU 104. The workload balancing may also reduce the temperature of the NPU 108 as well as the CPU 102 and the GPU 104. Moreover, the process 600 may also be applied to CPU 102 or GPU 104 to manage the temperature of such processors and balance the ML workload processed by each. In some aspects, the process 600 may return to block 604 if one or more of the conditions of block 610 are met.

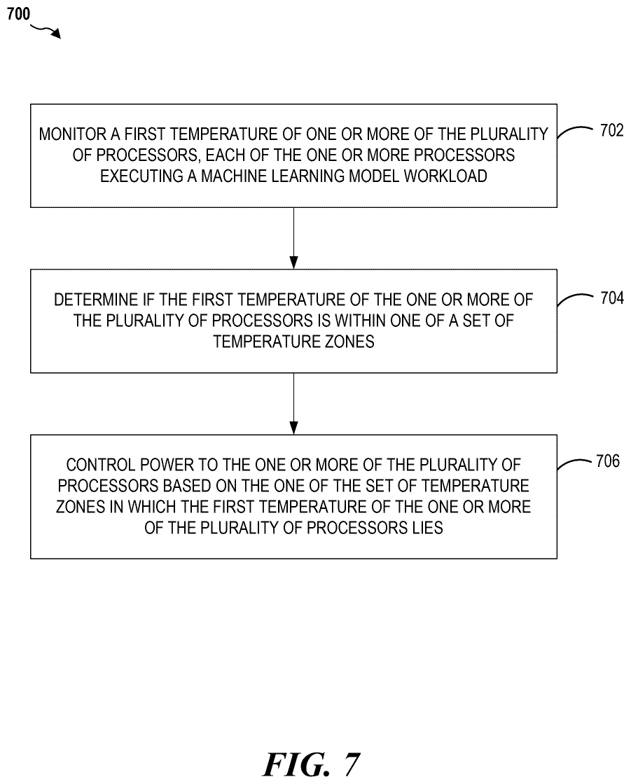

FIG. 7 is a flow diagram illustrating a processor-implemented method 700 for thermal aware power/performance management for concurrent operation of large models, in accordance with various aspects of the present disclosure. The processor-implemented method 700 may be performed by one or more processors such as the CPU (e.g., 102, 422), GPU (e.g., 104, 426), and/or other processing unit (e.g., DSP 106, 424, NPU 108, 428), for example.

Referring to FIG. 7, at block 702, the one or more processors monitoring a first temperature of one or more of the plurality of processors, each of the one or more processors executing a machine learning model workload. For instance, as described with reference to FIG. 5, the temperatures of the NPUs may be monitored for instance using one or more temperature sensors (e.g., 114 of FIG. 1). As shown in the example of FIGURE, curves 502a-d represent the temperature measured at each of multiple NPUs (e.g., NPU0, NPU1, NPU2, NPU3).

At block 704, the one or more processors determining if the first temperature of the one or more of the plurality of processors is within one of a set of temperature zones. As described, for example, with reference to FIG. 6, at block 604, the example process 600 may determine the temperature (Tₙ) of the NPU 108 and enable temperature zone-based sleep/idle modes. For example, the temperature (Tₙ) of the NPU 108 may be detected using one or more sensors (e.g., 114 of FIG. 1).

The zone (e.g., 504a-c) in which the temperature (Tₙ) lies may be determined. The slope of the temperature (Tₙ) curve (e.g., 504a-d) for the NPU 108 may also be determined according to

$$Slope ( m ) = \frac{{T}_{2} - {T}_{1}}{{t}_{2} - {t}_{1}} ,$$

where Tₙ is the temperature and tₙ is a time.

At block 706, the one or more processors controlling power to the one or more of the plurality of processors based on the one of the set of temperature zones in which the first temperature of the one or more of the plurality of processors lies. For example, as described with reference to FIG. 6, if the temperature (Tₙ) is within the first zone (e.g., zone 1 504a of FIG. 5), then a short sleep mode may be enabled. During short sleep, the clock speed of NPU 108 may be reduced and certain functional blocks may be disabled temporarily (e.g., for a predetermined time period). If the temperature (Tₙ) is either within the second zone or within the first zone (e.g., zone 1 504a of FIG. 5) and the slope m at the first zone is greater than a first predefined threshold value x, then a medium sleep mode may be enabled. The first predefined threshold may be a tunable slope value (e.g., based on how quickly the temperature may increase). If the temperature (Tₙ) is either within the third zone (e.g., zone 3 504c) or within the second zone (e.g., zone 2 504b), and the slope m is greater than the predefined threshold value x, then the process 600 may enable a long sleep mode. In the long sleep mode, the power of the NPU may be reduced, cache and internal registers may be flushed.

In some aspects, different threshold values may be employed based on the temperature zone. Additionally, in some aspects, the process 600 may initiate a transition to lower operating parameters (e.g., frequency or voltage).

### Example Aspects

Aspect 1: An apparatus, comprising: at least one memory; and a plurality of processors coupled to the at least one memory, at least one processor of the plurality of processors configured to: monitor a first temperature of one or more of the plurality of processors, each of the one or more processors executing a machine learning model workload; determine if the first temperature of the one or more of the plurality of processors is within one of a set of temperature zones; and control power to the one or more of the plurality of processors based on the one of the set of temperature zones in which the first temperature of the one or more of the plurality of processors lies.

Aspect 2: The apparatus of Aspect 1, wherein the at least one processor is further configured to: determine a slope of a first temperature curve within each of the set of temperature zones; and control the power to the one or more of the plurality of processors based on the slope of the first temperature curve within the one of the set of temperature zones in which the first temperature of the one or more of the plurality of processors lies.

Aspect 3: The apparatus of Aspect 1 or 2, wherein the at least one processor is further configured to control the power to the one or more of the plurality of processors to: trigger a short sleep mode in response to the first temperature of the one or more of the plurality of processors being in a first temperature zone; trigger a medium sleep mode in response to either the first temperature of the one or more of the plurality of processors being in a second temperature zone or the first temperature of the one or more of the plurality of processors being in the first temperature zone and the slope of the first temperature curve within the first temperature zone exceeding a predefined slope threshold; and trigger a long sleep mode in response to either the first temperature of the one or more of the plurality of processors being in a third temperature zone or the first temperature of the one or more of the plurality of processors being in the second temperature zone and the slope of the first temperature curve within the second temperature zone exceeding the predefined slope threshold.

Aspect 4: The apparatus of any preceding Aspect, wherein the at least one processor is further configured to control the power to the one or more of the plurality of processors to disable one or more functional blocks of the one or more of the plurality of processors based on whether the short sleep mode, the medium sleep mode or the long sleep mode is triggered.

Aspect 5: The apparatus of any preceding Aspect, wherein the at least one processor is further configured to control the power to the one or more of the plurality of processors based on a second temperature of at least one other processor of the one or more of the plurality of processors.

Aspect 6: The apparatus of any preceding Aspect, wherein multiple processors are concurrently executing different machine learning model workloads.

Aspect 7: The apparatus of any preceding Aspect, wherein the one or more processors comprise a neural processing unit.

Aspect 8: A processor-implemented method performed by at least one processor, the processor-implemented method comprising: monitoring a first temperature of one or more of the plurality of processors, each of the one or more processors executing a machine learning model workload; determining if the first temperature of the one or more of the plurality of processors is within one of a set of temperature zones; and controlling power to the one or more of the plurality of processors based on the one of the set of temperature zones in which the first temperature of the one or more of the plurality of processors lies.

Aspect 9: The processor-implemented method of Aspect 8, further comprising: determining a slope of a first temperature curve within each of the set of temperature zones; and controlling the power to the one or more of the plurality of processors based on the slope of the first temperature curve within the one of the set of temperature zones in which the first temperature of the one or more of the plurality of processors lies.

Aspect 10: The processor-implemented method of Aspect 8 or 9, further comprising controlling the power to the one or more of the plurality of processors to: trigger a short sleep mode in response to the first temperature of the one or more of the plurality of processors being in a first temperature zone; trigger a medium sleep mode in response to either the first temperature of the one or more of the plurality of processors being in a second temperature zone or the first temperature of the one or more of the plurality of processors being in the first temperature zone and the slope of the first temperature curve within the first temperature zone exceeding a predefined slope threshold; and trigger a long sleep mode in response to either the first temperature of the one or more of the plurality of processors being in a third temperature zone or the first temperature of the one or more of the plurality of processors being in the second temperature zone and the slope of the first temperature curve within the second temperature zone exceeding the predefined slope threshold.

Aspect 11: The processor-implemented method of any of Aspects 8-10, further comprising controlling the power to the one or more of the plurality of processors to disable one or more functional blocks of the one or more of the plurality of processors based on whether the short sleep mode, the medium sleep mode or the long sleep mode is triggered.

Aspect 12: The processor-implemented method of any of Aspects 8-11, further comprising controlling the power to the one or more of the plurality of processors based on a second temperature of at least one other processor of the one or more of the plurality of processors.

Aspect 13: The processor-implemented method of any of Aspects 8-12, wherein multiple processors are concurrently executing different machine learning model workloads.

Aspect 14: The processor-implemented method of any of Aspects 8-13, wherein the one or more processors comprise a neural processing unit.

Aspect 15: An apparatus, comprising: means for monitoring a first temperature of one or more of the plurality of processors, each of the one or more processors executing a machine learning model workload; means for determining if the first temperature of the one or more of the plurality of processors is within one of a set of temperature zones; and means for control power to the one or more of the plurality of processors based on the one of the set of temperature zones in which the first temperature of the one or more of the plurality of processors lies.

Aspect 16: The apparatus of Aspect 15, further comprising: means for determining a slope of a first temperature curve within each of the set of temperature zones; and means for controlling the power to the one or more of the plurality of processors based on the slope of the first temperature curve within the one of the set of temperature zones in which the first temperature of the one or more of the plurality of processors lies.

Aspect 17: The apparatus of Aspect 15 or 16, further comprising means for controlling the power to the one or more of the plurality of processors to: trigger a short sleep mode in response to the first temperature of the one or more of the plurality of processors being in a first temperature zone; trigger a medium sleep mode in response to either the first temperature of the one or more of the plurality of processors being in a second temperature zone or the first temperature of the one or more of the plurality of processors being in the first temperature zone and the slope of the first temperature curve within the first temperature zone exceeding a predefined slope threshold; and trigger a long sleep mode in response to either the first temperature of the one or more of the plurality of processors being in a third temperature zone or the first temperature of the one or more of the plurality of processors being in the second temperature zone and the slope of the first temperature curve within the second temperature zone exceeding the predefined slope threshold.

Aspect 18: The apparatus of any of Aspects 15-17, further comprising means for controlling the power to the one or more of the plurality of processors to disable one or more functional blocks of the one or more of the plurality of processors based on whether the short sleep mode, the medium sleep mode or the long sleep mode is triggered.

Aspect 19: The apparatus of any of Aspects 15-18, further comprising means for controlling the power to the one or more of the plurality of processors based on a second temperature of at least one other processor of the one or more of the plurality of processors.

Aspect 20: The apparatus of any of Aspects 15-19, wherein multiple processors are concurrently executing different machine learning model workloads.

In one aspect, the monitoring means, determining means, and/or controlling means may be the CPU 102/422, GPU 104/426, NPU 108/428, program memory associated with the CPU 102/422, GPU 104/426, or NPU 108/428, memory 118, and/or the sensors 114 configured to perform the functions recited. In another configuration, the aforementioned means may be any module or any apparatus configured to perform the functions recited by the aforementioned means.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used, the term “determining” encompasses a wide variety of actions. For example, “determining” may include calculating, computing, processing, deriving, investigating, looking up (e.g., looking up in a table, a database, or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used, include compact disc (CD), laser disc, optical disc, digital versatile disc (DVD), floppy disk, and Blu-ray® disc where disks usually reproduce data magnetically, while discs reproduce data optically with lasers. Thus, in some aspects, computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented. For example, such a computer program product may comprise a computer-readable medium having instructions stored (and/or encoded) thereon, the instructions being executable by one or more processors to perform the operations described. For certain aspects, the computer program product may include packaging material.

Further, it should be appreciated that modules and/or other appropriate means for performing the methods and techniques described can be downloaded and/or otherwise obtained by a user terminal and/or base station as applicable. For example, such a device can be coupled to a server to facilitate the transfer of means for performing the methods described. Alternatively, various methods described can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. An apparatus, comprising:
at least one memory; and
a plurality of processors coupled to the at least one memory, at least one processor of the plurality of processors configured to:
monitor a first temperature of one or more of the plurality of processors, each of the one or more processors executing a machine learning model workload;
determine if the first temperature of the one or more of the plurality of processors is within one of a set of temperature zones; and
control power to the one or more of the plurality of processors based on the one of the set of temperature zones in which the first temperature of the one or more of the plurality of processors lies.

2. The apparatus of claim 1, wherein the at least one processor is further configured to:
determine a slope of a first temperature curve within each of the set of temperature zones; and
control the power to the one or more of the plurality of processors based on the slope of the first temperature curve within the one of the set of temperature zones in which the first temperature of the one or more of the plurality of processors lies.

3. The apparatus of claim 2, wherein the at least one processor is further configured to control the power to the one or more of the plurality of processors to:
trigger a short sleep mode in response to the first temperature of the one or more of the plurality of processors being in a first temperature zone;
trigger a medium sleep mode in response to either the first temperature of the one or more of the plurality of processors being in a second temperature zone or the first temperature of the one or more of the plurality of processors being in the first temperature zone and the slope of the first temperature curve within the first temperature zone exceeding a predefined slope threshold; and
trigger a long sleep mode in response to either the first temperature of the one or more of the plurality of processors being in a third temperature zone or the first temperature of the one or more of the plurality of processors being in the second temperature zone and the slope of the first temperature curve within the second temperature zone exceeding the predefined slope threshold.

4. The apparatus of claim 3, wherein the at least one processor is further configured to control the power to the one or more of the plurality of processors to disable one or more functional blocks of the one or more of the plurality of processors based on whether the short sleep mode, the medium sleep mode or the long sleep mode is triggered.

5. The apparatus of claim 1, wherein the at least one processor is further configured to control the power to the one or more of the plurality of processors based on a second temperature of at least one other processor of the one or more of the plurality of processors.

6. The apparatus of claim 1, wherein multiple processors are concurrently executing different machine learning model workloads.

7. The apparatus of claim 1, wherein the one or more processors comprise a neural processing unit.

8. A processor-implemented method performed by at least one processor, the processor-implemented method comprising:
monitoring a first temperature of one or more of the plurality of processors, each of the one or more processors executing a machine learning model workload;
determining if the first temperature of the one or more of the plurality of processors is within one of a set of temperature zones; and
controlling power to the one or more of the plurality of processors based on the one of the set of temperature zones in which the first temperature of the one or more of the plurality of processors lies.

9. The processor-implemented method of claim 8, further comprising:
determining a slope of a first temperature curve within each of the set of temperature zones; and
controlling the power to the one or more of the plurality of processors based on the slope of the first temperature curve within the one of the set of temperature zones in which the first temperature of the one or more of the plurality of processors lies.

10. The processor-implemented method of claim 9, further comprising controlling the power to the one or more of the plurality of processors to:
trigger a short sleep mode in response to the first temperature of the one or more of the plurality of processors being in a first temperature zone;
trigger a medium sleep mode in response to either the first temperature of the one or more of the plurality of processors being in a second temperature zone or the first temperature of the one or more of the plurality of processors being in the first temperature zone and the slope of the first temperature curve within the first temperature zone exceeding a predefined slope threshold; and
trigger a long sleep mode in response to either the first temperature of the one or more of the plurality of processors being in a third temperature zone or the first temperature of the one or more of the plurality of processors being in the second temperature zone and the slope of the first temperature curve within the second temperature zone exceeding the predefined slope threshold.

11. The processor-implemented method of claim 10, further comprising controlling the power to the one or more of the plurality of processors to disable one or more functional blocks of the one or more of the plurality of processors based on whether the short sleep mode, the medium sleep mode or the long sleep mode is triggered.

12. The processor-implemented method of claim 8, further comprising controlling the power to the one or more of the plurality of processors based on a second temperature of at least one other processor of the one or more of the plurality of processors.

13. The processor-implemented method of claim 8, wherein multiple processors are concurrently executing different machine learning model workloads.

14. The processor-implemented method of claim 8, wherein the one or more processors comprise a neural processing unit.

15. An apparatus, comprising:
means for monitoring a first temperature of one or more of the plurality of processors, each of the one or more processors executing a machine learning model workload;
means for determining if the first temperature of the one or more of the plurality of processors is within one of a set of temperature zones; and
means for control power to the one or more of the plurality of processors based on the one of the set of temperature zones in which the first temperature of the one or more of the plurality of processors lies.

16. The apparatus of claim 15, further comprising:
means for determining a slope of a first temperature curve within each of the set of temperature zones; and
means for controlling the power to the one or more of the plurality of processors based on the slope of the first temperature curve within the one of the set of temperature zones in which the first temperature of the one or more of the plurality of processors lies.

17. The apparatus of claim 16, further comprising means for controlling the power to the one or more of the plurality of processors to:
trigger a short sleep mode in response to the first temperature of the one or more of the plurality of processors being in a first temperature zone;
trigger a medium sleep mode in response to either the first temperature of the one or more of the plurality of processors being in a second temperature zone or the first temperature of the one or more of the plurality of processors being in the first temperature zone and the slope of the first temperature curve within the first temperature zone exceeding a predefined slope threshold; and
trigger a long sleep mode in response to either the first temperature of the one or more of the plurality of processors being in a third temperature zone or the first temperature of the one or more of the plurality of processors being in the second temperature zone and the slope of the first temperature curve within the second temperature zone exceeding the predefined slope threshold.

18. The apparatus of claim 17, further comprising means for controlling the power to the one or more of the plurality of processors to disable one or more functional blocks of the one or more of the plurality of processors based on whether the short sleep mode, the medium sleep mode or the long sleep mode is triggered.

19. The apparatus of claim 15, further comprising means for controlling the power to the one or more of the plurality of processors based on a second temperature of at least one other processor of the one or more of the plurality of processors.

20. The apparatus of claim 15, wherein multiple processors are concurrently executing different machine learning model workloads.
